(19) United States
(12) Patent Application Publication
(10) Pub. No.: US 2016/0151864 A1
(43) Pub. Date: Jun. 2, 2016

(54) METAL SINTERING FILM COMPOSITIONS

(71) Applicant: Henkel IP & Holding GmbH, Duesseldorf (DE)

(72) Inventors: Louis P. Rector, Rancho Santa Margarita, CA (US); Harry Richard Kuder, Fullerton, CA (US); Juliet Grace Sanchez, Carson, CA (US); Albert P. Perez, La Habra, CA (US); Kathryn Bearden, Aliso Viejo, CA (US)

(21) Appl. No.: 15/017,755

(22) Filed: Feb. 8, 2016

Related U.S. Application Data
(63) Continuation of application No. PCT/US2014/045862, filed on Jul. 9, 2014.
(60) Provisional application No. 61/873,862, filed on Sep. 5, 2013.

(51) Int. Cl. B23K 35/30; B23K 35/362; B23K 35/26; C22C 38/52; C22C 9/00; C22C 38/04; C22C 38/02; C22C 38/00; C22C 13/00; C22C 5/06; B23K 35/02; C22C 38/06

(52) U.S. Cl. CPC B23K 35/3006; B23K 35/0233; B23K 35/362; B23K 35/302; B23K 35/3066; B23K 35/262; C22C 38/52; C22C 38/06; C22C 38/04; C22C 38/02; C22C 38/002; C22C 13/00; C22C 5/06; C22C 9/00

(57) ABSTRACT

A sintering film comprising one or more metals, one or more metal alloys, or blends of one or more metals and one or more metal alloys, is prepared optionally using a solid or semi-solid organic binder. The organic binder can have fluxing functionality; the organic binder can be one that will partially or completely decompose upon sintering of the metal or metal alloy in the composition. In one embodiment, the sintering film is provided on an end use substrate, such as a silicon die or wafer, or a metal circuit board or foil, or the sintering film is provided on a carrier, such as a metal mesh. Preparation is accomplished by dispersing the metal or metal alloy in a suitable solvent, with or without a binder, and exposing the composition to high temperature to evaporate off the solvent and partially sinter the metal or metal alloy.

### BACKGROUND

1. Field

Metal films useful for bonding applications within various industries are provided. The metal films are particularly suitable for use within the semiconductor industry, where in application the films sinter when exposed to elevated temperature conditions and form an electrical interconnection between two substrates on which they are applied.

2. Brief Description of Related Technology

Traditionally, conductive adhesive compositions comprising an adhesive resin and conductive fillers have been used in the fabrication and assembly of semiconductor packages and microelectronic devices to mechanically attach and create electrical and/or thermal conductivity between integrated circuit devices and their substrates. These are paste compositions, which when used over large bonding areas, have been observed to generate voids during cure and resin bleed out with residue at the fillet areas. The presence of voids diminishes the reliability of the adhesive.

Consequently, it would be advantageous to provide conductive adhesive compositions in film form because in film format reduced voiding should be observed, improved planarity of bond line thickness can be maintained, and elimination or at least reduction of resin bleed out or the accumulation of residue at the edge of die or fillet areas can be achieved. In addition, end users would benefit from more facile application and reduced opportunity for spillage or contamination in use.

### SUMMARY

Provided herein is a composition of matter comprising one or more metals and/or one or more metal alloys, where the one or more metals and/or one or more metal alloys are present in a high melting point phase and a low metal point phase, where the low melting point phase melts at a temperature of less than about 300° C.

The low melting point phase when exposed to a temperature of greater than 50° C. but less than about 300° C. melts and forms intermetallic compounds with the high melting point phase. The intermetallic compounds ordinarily are formed in the composition at a level of less than 100%. In some instances, it may be desirable to form intermetallic connections with the surfaces to be joined.

The low melting point phase is present in an amount of at least 5%, such as 30%, by weight of the composition of matter.

Desirably, the composition of matter is in the form of a sintering film.

In an alternative embodiment, a composition of matter is provided that comprises a metal or a metal alloy and a decomposable organic binder, which when exposed to a temperature of greater than 50° C., where the metal sinters and is in the form of a film. Here, the metal should sinter in the composition at a level of less than 100%.

In use, the composition of matter when in film form should be disposed between a semiconductor chip and a circuit board or a carrier substrate. Desirably, the composition of matter when in film form should be disposed on a surface of a silicon wafer, where the surface of the silicon wafer contains a metallization layer.

Prior to use, the composition of matter when in the form of a sintering film may be considered an article of commerce with the sintering film disposed on a carrier, such as a carrier film, a metal foil, or a ceramic support.

In practice, the sintering film once disposed on a desired substrate will be subjected to elevated temperature conditions sufficient to cause further sintering of the film. The further sintering should permit the joining of two substrates between which the film is placed. Where the substrates are constructed from metal, metal oxides or other conductive materials, or coated, layered or patterned with such a metal, metal oxide or material, an electrical interconnection between the two substrates is formed.

Also provided herein is a method for preparing a sintering film comprising (a) dispersing the metal and/or metal alloy in a suitable solvent, with or without a binder, to form a sintering paste, (b) applying the sintering paste to a substrate, and (c) heating the sintering paste to dry it into the sintering film. Heating the sintering paste to dry it into a film is referred to herein as B-staging.

The sintering films offer economic advantages as they are cleaner and easier to use than flowable conductive compositions.

### DETAILED DESCRIPTION

As noted above, provided herein is a composition of matter comprising one or more metals and/or one or more metal alloys, where the one or more metals and/or one or more metal alloys are present in a high melting point phase and a low metal point phase, where the low melting point phase melts at a temperature of less than about 300° C.

The low melting point phase when exposed to a temperature of greater than 50° C. but less than about 300° C. melts and forms intermetallic compounds with the high melting point phase. The intermetallic compounds ordinarily are formed in the composition at a level of less than 100%. In some instances, it may be desirable to form intermetallic connections with the surfaces to be joined.

The low melting point phase is present in an amount of at least 5%, such as 30%, by weight of the composition of matter.

Desirably, the composition of matter is in the form of a sintering film.

Also as noted above, in an alternative embodiment, a composition of matter is provided that comprises a metal or a metal alloy and a decomposable organic binder, which when exposed to a temperature of greater than 50° C., where the metal sinters and is in the form of a film. Here, the metal should sinter in the composition at a level of less than 100%.

In use, the composition of matter when in film form should be disposed between a semiconductor chip and a circuit board or a carrier substrate. Desirably, the composition of matter when in film form should be disposed on a surface of a silicon wafer, where the surface of the silicon wafer contains a metallization layer.

Prior to use, the composition of matter when in the form of a sintering film may be considered an article of commerce with the sintering film disposed on a carrier, such as a carrier film, a metal foil, or a ceramic support.

The sintering film is sintered to some degree (the relative amount of sintering may vary depending on the precise nature of the constituents used to make the film). As noted above, the metal sinters at a level of less than 100%.

In practice, the sintering film once disposed on a desired substrate will be subjected to elevated temperature conditions sufficient to cause further sintering of the film. The further sintering should permit the joining of two substrates between which the film is placed. Where the substrates are constructed from metal, metal oxides or other conductive materials, or coated, layered or patterned with such a metal, metal oxide or other conductive material, an electrical interconnection between the two substrates is formed.

In the embodiment in which more than one metal or more than one metal alloy is used, one of the metals or one of the metal alloys will have a lower melting point phase than that of the other.

In another embodiment, the sintering film further comprises a solid or semi-solid organic binder; the organic binder may also have fluxing functionality. It is desirable that the organic binder be one that at least partially decomposes upon sintering of the metal or metal alloy in the composition.

In another embodiment, the sintering film is provided on a carrier, such as a release liner, to form an article of manufacture. In yet another embodiment, the sintering film is provided on an end use substrate, such as a silicon die or wafer, or a metal circuit board or foil. In a further embodiment, the sintering composition is impregnated into a carrier, such as a conductive metal or polymeric mesh, or a porous substrate, such as metal, ceramic, or polymeric substrate that can be incorporated into the sintered matrix, or that can be burned off during sintering. Here, the sintering film is deposed on a substrate, which may comprise a sheet of polyester or silicone-coated paper.

The sintering films should be formed to a desired thickness, as appropriate for the commercial application at hand. For instance, the sintering films may be formed to a thickness of 0.5 to 3 mil, when laid upon a carrier. Once the so formed sintering film has been applied to the carrier, the film may be cut preferably by way of die cutting to desired shapes and dimensions and readily removed or peeled away from the carrier and placed into position at the desired interface. In this respect, the film may be pre-cut as appropriate for a given commercial application.

The sintering films may be formed as films cut to specified dimensions for quick and accurate application to a given substrate, such as a release liner like one made from a polyester release substrate or silicone-coated substrate. The sintering films are capable of being applied to such substrate and thereafter shipped to a desired location without becoming misshaped or otherwise deformed.

Advantageously, due to their capability of being shipped in film form, the sintering films are thus in a state conducive to being an article of commerce, whereby they are prepared in one location, packaged and shipped to another location for application to a given substrate.

The sintering film formed upon the release substrate may be pre-cut to desired dimensions, such that a multiplicity of film segments are formed, each of which may be removed from the substrate and selectively positioned at a desired interface.

Suitable metals for the sintering film can be any conductive metal and/or metal alloy. In various embodiments, the metals and metal alloys are selected from the group consisting of silver, copper, nickel, tin, and their alloys. Particularly useful alloys are selected from copper-tin, copper-zinc, copper-nickel-zinc; iron-nickel alloy; tin-bismuth alloy, tin-silver alloy, tin-silver-copper alloy; silver-coated copper-zinc alloy, silver-coated copper-nickel-zinc alloy, silver-coated copper-tin alloy, tin-coated copper, and eutectic Sn:Bi-coated copper. Further suitable metals are selected from metal-coated boron nitride, metal-coated glass, metal-coated graphite and metal-coated ceramic. These and similar metals and metal alloys are commercially available.

Metal- or metal-alloy coated particles may also be used. For instance, tin-bismuth-coated copper, tin-coated copper, and silver-coated boron nitride, are just but a few examples. The metal- or metal alloy-coated particles may be viewed as a metal or metal alloy-coated core.

The metal or metal alloys can be in any suitable form, such as, powders, flakes, spheres, tubes, or wires.

In further embodiments, additional conductive particles, such as, graphene, carbon nanotubes, or organic conductive polymers, can be included.

When a binder is used, the binder will be a solid or semi-solid compound. In one embodiment the binder will have fluxing functionality; in some embodiments the fluxing functionality is from groups selected from hydroxyl, carboxyl, anhydride, ester, amine, amide, thiol, thioester, and phosphate ester groups.

In one embodiment, the binder is a compound with a softening point less than 50° C.; this low softening point allows for low temperature lamination of the prepared sintering film to a desired substrate. Such binders may or may not have polymerizable functionality. Suitable binders include Sekicui S-LEC AS C-4 acrylic resin, used in Example 1 of this description, and ISP Ganex V-220 alkylated polyvinylpyrrolidone.

Binder compounds with a softening point less than 50° C. also include those with fluxing functionality. In one embodiment, the binder will be a polymer, such as an acrylic resin, functionalized with carboxylic acid or maleic anhydride to add fluxing functionality. Exemplary binders of this type include ISP I-REZ 160 copolymer isobutylene-maleic anhydride resin as used in Example 2; and BASF QPAC-40 poly-(alkylene carbonate) copolymer with epoxide. In general, suitable binders include, but are not limited to, anhydride-acid functional binders and naturally occurring rosin binders.

Binder compounds also include those that thermally decompose at temperatures of ≦350° C., such as of δ275° C. Decomposition typically will be achieved for the prepared film by a temperature ramp to the decomposition temperature and/or a hold time at the decomposition temperature. Suitable compounds include Sekicui S-LEC AS C-4 acrylic resin and ISP I-REZ 160 copolymer of isobutylene and maleic anhydride resin.

In addition, thermally decomposable binder compounds also include those with fluxing functionality. Such compounds have fluxing functionality from groups including, but not limited to, hydroxyl, carboxyl, anhydride, ester, amine, amide, thiol, thioester, and phosphate ester groups.

For some applications, the sintering composition will further comprise a sintering aid selected from an alkali metal, an alkali metal salt, a transition metal, and a transition metal salt (in which the salts are alkali or transition metals coordinated with an organic acid). The sintering aid is present at a level of ≦5.0% by weight of the components of the sintering film. The alkali and transition metals and their salts typically are used to improve the sintering of silver and to permit sintering at a temperature of ≦350° C. of copper flakes and alloy-42 flakes.

Suitable metals are selected from Li, Na, K, Rb, Be, Mg, Ca, Sr, Ba, Ti, Zr, V, Nb, Ta, Cr, Mo, W, Mn, Fe, Ru, Os, Co, Rh, Ir, Ni, Pd, Pt, Cu, Ag, Au, Zn, Cd, B, Al, Ga, In, Si, Ge, Sn, Pb, N, P, As, Sb, and Bi. Suitable organic acids to coordinate with the metals are selected from formic, acetic, acrylic, methacrylic, propionic, butyric, valeric, caproic, caprylic, carpric, lauric, myristic, palmitic, stearic, oleic, linoleic, linolenic, cyclohexanecarboxylic, phenylacetic, benzoic, o-toluic, m-toluic, p-toluic, o-chlorobenzoic, m-chlorobenzoic, p-chlorobenzoic, o-bromobenzoic, m-bromobenzoic, p-bromobenzoic, o-nitrobenzoic, m-nitrobenzoic, p-nitrobenzoic, phthalic, isophthalic, terephthalic, salicylic, p-hydroxybenzoic, anthranilic, m-aminobenzoic, p-aminobenzoic, o-methoxybenzoic, m-methoxybenzoic, p-methoxybenzoic, oxalic, malonic, succinic, glutaric, adipic, pimelic, suberic, azelaic, sebacic, maleic, fumaric, hemimellitic, trimellitic, trimesic, malic, and citric acids, the branched chain isomers of these acids, and halogen-substituted derivatives of these acids.

These carboxylic acids are either commercially available or readily synthesizable by one skilled in the art. The metal salts of these carboxylic acids are generally solid materials that can be milled into a fine powder for incorporating into the chosen resin composition. The metal salt will be loaded into the resin composition at a loading of 0.05% to 10% by weight of the formulation. In one embodiment, the loading is around 0.1% to 0.5% by weight.

In various embodiments, the sintering aids are selected from lithium acetate, lithium acetylacetonate, lithium benzoate, lithium phosphate, palladium, palladium methacrylate, palladium (II) acetylacetonate and tin (II) 2-ethyl hexanoate.

The sintering film may be prepared by the process comprising dispersing one or more metals and/or one or more metal alloys in a suitable solvent, with or without a binder, to form a sintering paste; applying the sintering paste to a substrate, and heating the sintering paste to dry it into the sintering film. The metals and metal alloys are as previously described. The binder is as previously described. The solvent evaporates as the sintering paste dries to a dimensionally stable film. Typical conditions for drying are at a temperature of ≦150° C. for a period of time of 60 minutes, although in some embodiments the temperature may be ≦260° C. For compositions that contain combinations of two or more different metals or metal alloys, the processing occurs at temperatures above the melting point of one of the metals or metal alloys.

Solvents are used to disperse or solvate the metal(s) or metal oxide(s), and the binder when present. Some solvents are also fluxing agents. Suitable solvents are oxygenated solvents and aprotic solvents that can accept hydrogen bonding and lack acidic hydrogen. In various embodiments the solvent is selected from butyl acetate, hexanediol, propylene carbonate, N-methyl-2-pyrrolidone, acetylacetone, 2-ethyl-1,3-hexanediol, 2-(2-ethyoxyethoxy)-ethylacetate, acetone, ethyl acetate, diethylene glycol monobutyl ether acetate, 2-butanone,m 1,4-dioxane, N-ethyl pyrrolidone, dimethyl formamide, cyclooctanone, diphenyl oxide, 2-phenyl-3-butyne-2-ol, dicyclopentadiene, and tetrahydrofurfuryl alcohol.

In some embodiments, the sintering film can be compressed after B-staging to improve the film density and reduce voids. The compression process will occur at a temperature ≦300° C., preferably ≦250° C., and more preferably ≦150° C. and at a pressure ≦15 mPa. The process can either be in a continuous (preferably) or batch process.

Where needed, the sintering film after B-staging can be reactivated by the application of a fluxing agent prior to use as a bonding adhesive.

The dry film can be further processed by printing to a desired substrate by thermo-compression methods at ≦260° C. and ≦50 Mpa, and desirably less than 15 Mpa.

Thus, in a further embodiment, a process for preparing a sintering film is provided that comprises (a) dispersing one or more metals and/or one or more metal alloys in a solvent, with or without a binder, to form a sintering paste; (b) applying the sintering paste to a substrate, and (c) heating the sintering paste to dry it into the sintering film. In further steps, the process comprises (d) compressing the film at a temperature ≦300° C. and a pressure ≦15 Mpa, and/or (e) laminating the film to a substrate.

The sintering film is oftentimes used in metal to metal bonding applications, particularly within the electronics industry, but also for other industrial applications where metal to metal bonding is required.

Within the electronics industry, these sintering films can be used as conductive wafer back side coatings or as die attach adhesives in which the processing temperature ranges from about 175° C. to 350° C. In some embodiments, the sintering films are disposed onto the desired substrate, for example, a silicon wafer when the sintering film is to be used as a wafer back side coating, or a laminate release liner when the sintering film is to be used as a conductive die attach adhesive.

In other end use applications, the sintering film can be printed onto a carrier film, metal foil, or ceramic support. The carrier film may be polymeric, such as, polyester, polyacrylate, or polyimide. The carrier film may also be a UV transparent tape. When the carrier film is a metal foil, the sintering film can be printed and B-staged on one side or both sides of the foil. For some uses, the combined thickness typically is less than 100 microns, but can be less than 50 microns.

In other embodiments, the sintering film may be infused into a foam or a mesh, in which the foam or mesh is composed of metal, polymer, or ceramic. Alternatively, the sintering film may be applied to a carrier, such as a carrier film, metal foil, or ceramic support.

The following examples should assist in illustrating but not limiting the invention.

### EXAMPLES

In the following examples sintering films were prepared from silver with decomposable binders and were evaluated as follows.

The test vehicles were metallized (titanium-nickel-silver) silicon dies on either copper or silver substrates as indicated.

Electrical conductivity, measured as volume resistivity, was measured with a four point probe on a Megohm bridge.

Thermal conductivity was measured by laser flash method using a Netzsch instrument.

Die shear strength (DSS) was measured on a Dage die shear tester using a silicon die metallized with titanium-nickel-silver and a bare copper or silver-coated copper substrate.

For all samples within the examples, die attach was achieved with manual attach or thermal compression attach. The samples were exposed twice to UV at 500 mj/Sq-cm for 30 seconds, and then attached to the chosen substrate with a Toray Engineering FC-100 die bonder at a bonding head force within the range of 10N to 150N at ≦275° C., from 0.1 second to 15 minutes depending on the sample. A post die attach sintering process was used to fully sinter, typically ≦60 minutes at ≦250° C.

Resistance, thermal conductivity, and die shear were measured for each of several formulations and the results recorded within the below examples. TGA is thermogravimetric analysis.

### Example 1

Films were prepared according to the formulae by weight in TABLE 1. When acrylic binder is used, peroxide is not added to the formula; this prevents cross-linking of the acrylic during B-staging. The sintering composition was heated for one hour at 150° C. to remove solvent and stabilize the composition into a sintering film. The film was used in the test vehicles described above. Data are also recorded in TABLE 1 and show that sintering films can be prepared using decomposable binders.

TABLE 1

| CONSTITUENTS | A | B |
|---|---|---|
| Silver powder (DOWA AG-SAB-136, Dmean = 0.9 | 60.0 | 60.0 |
| microns) | | |
| Silver flake (DOWA FA-DAB-195, Dmean = 2.4 | 40.0 | 40.0 |
| microns) | | |
| Acrylic resin binder (Sekicui S-LEC AS C-4) 30% | | 10.0 |
| solution in butyl acetate; softening point 30° C. | | |
| 2-Ethyl-1,3-hexanediol (solvent) | 12.0 | |
| Diethylene glycol monobutyl ether acetate (solvent) | | 10.0 |
| Acetylacetone (fluxing agent) | 3.0 | 3.0 |
| Di-tert-butyl peroxide | 1.0 | |
| TGA temperature required to burn out organics (° C.) | ≦250 | 250 |
| TGA Time @ 250° C. to burn out organics (minutes) | 6.5 | 10.0 |
| Volume resistance (Ω-cm) | 0.7 × 10-5 | 0.9 × 10-5 |
| Thermal conductivity (W/m°K) | 168 | 121 |
| DSS after heating for 60 min at 150° C. and | 4.2 | 3.7 |
| die-attach for 30 seconds/45N force (kg/mm²) | | |

### Example 2

In this example a linear copolymer of alternating isobutylene and maleic anhydride groups was used as the binder. The copolymer has fluxing functionality, a softening point of 37° C., and a molecular weight of 78,000-94,000. Die shear was performed on silver and copper substrates as indicated. The results are recorded in TABLE 2 and show improved adhesion and low temperature lamination and die attach for the sample containing the copolymer binder.

TABLE 2

| CONSTITUENTS | C | D |
|---|---|---|
| Silver powder (DOWA AG-SAB-136) | 60.0 | 60.0 |
| Silver flake (DOWA FA-DAB-195) | 40.0 | 40.0 |
| Copolymer isobutylene-maleic anhydride | | 3.2 |
| (fluxing resin) (ISP I-REZ 160) | | |
| 2-Ethyl-1,3-hexanediol (solvent) | 12.0 | |
| Propylene carbonate (solvent) | | 8.4 |
| N-methyl-2-pyrrolidone (solvent) | | 8.4 |
| Acetylacetone (fluxing agent) | 3.0 | 3.0 |
| Di-tert-butyl peroxide | 1.0 | 1.0 |
| Volume resistivity (Ω-cm) | 0.7 × 10-5 | 1.3 × 10-5 |
| DSS/Ag substrate (kg/mm2) | 1.5 | 2.2 |
| DSS/Cu substrate (kg/mm2) | 1.5 | 1.7 |

### Example 3

In this example, lithium alkali metal and palladium transition metal are added to the sintering composition to enhance sintering. The sintering profile for silver was 30 minutes ramp to 250° C. plus 60 minutes at 250° C. The sintering ramp for copper and alloy-42 was 350° C. plus 60 minutes at 350° C. The silver sintered sufficiently to make intermetallic connections to have adhesive strength between metal bonding surfaces. The copper and alloy sintered, but not with other metallization to improve adhesion. The results are recorded in TABLE 3.

TABLE 3

| CONSTITUENTS | E | F | G |
|---|---|---|---|
| Silver flake (DOWA FA-DAB-195) | 100.0 | | |
| Copper flake (Type-A DOWA QCS-7) | | 100.0 | |
| Alloy-42 (milled and washed) | | | 100.0 |
| (Novamet) | | | |
| 2-Ethyl-1,3-hexanediol (solvent) | 5.0 | 5.0 | 5.0 |
| 2-(2-Ethoxyethoxy)-ethyl acetate | 10.0 | 10.0 | 10.0 |
| (solvent) | | | |
| Lithium-phosphate (alkali metal) | 0.5 | 0.5 | 0.5 |
| Pd(II)-acetylacetonate (transition | | 0.5 | |
| metal) | | | |
| Acetylacetone (fluxing agent) | 1.0 | 1.0 | 1.0 |
| Triethanolamine (reducing agent) | 0.1 | 0.1 | 0.1 |
| Di-tert-butyl peroxide | 0.5 | | |
| Volume resistivity (Ω-cm) | 9.3 × 10-6 | 1.5 × 10-4 | 5.3 × 10-2 |
| Thermal conductivity (W/m°K) | 205 | 10 | not sinter |
| DSS/Ag substrate (kg/mm²) | 2.6 | die off | not sinter |

### Example 4

In this example, a sintering film was prepared from the composition in TABLE 4 containing alloy combinations. The film was prepared by printing a two mil film of the composition on a polyimide substrate, B-staging the composition in a 260° C. peak solder reflow process, hot pressing (at approximately 0.65-0.75 MPa (100-110 psi) and 200° C.) between two polyimide films for two minutes, exposing the sintering film, dipping the sintering film in a 15% azelaic acid solution in tetrahydrofurfyl alcohol, and then using the film to bond a die to a copper substrate at 5N and 240° C. for 30 seconds. This application of a flux solution was used to re-activate the film surface prior to bonding. The application of pressure was used to improve film density prior to bonding. The results are recorded in TABLE 4.

TABLE 4

| CONSTITUENTS | H |
|---|---|
| Copper-silver composite flake | 36.0 |
| approx. 50 wt % Ag (Metalor P300-4) | |
| 96.5 Sn/3.0 Ag/0.5 Cu alloy powder | 45.9 |
| (SAC 305 Type 3 97 SCDAP) particle | |
| size 45-25 μm | |
| 96.5 Sn/3.0 Ag/0.5 Cu alloy powder | 8.1 |
| (SAC 305 Type 7 97 SCDAP) particle | |
| size 10-1 μm | |
| Tetrahydrofurfuryl alcohol (solvent) | 8.7 |
| Azelaic acid (fluxing agent) | 1.3 |
| Room Temp DSS/Cu substrate | 5.2 |
| (kg/mm²) | |

### Example 5

This example shows the benefit of adding a metal salt to the sintering composition. Example I contained no metal salt and the die shear strength is commercially acceptable. Example J, which did contain metal salt, exhibited a higher die shear strength, indicating that the addition of a metal salt can improve the die shear strength of the composition. The results are reported in TABLE 5.

TABLE 5

| CONSTITUENTS | I | J |
|---|---|---|
| Copper powder (DOWA QCS-8) | 30 | 30 |
| 96.5 Sn/3.5 Ag alloy powder (Gesick) | 60 | 60 |
| Tin(2+)2-ethyl hexanoate (salt of caproic | 0 | 1.5 |
| acid) | | |
| Tetrahydrofurfuryl alcohol (solvent) | 8.5 | 7.0 |
| Azelaic acid (fluxing agent) | 1.5 | 1.5 |
| Room Temp DSS/Cu substrate (kg/mm²) | 3.9 | 9.1 |

1. A composition of matter comprising one or more metals and/or one or more metal alloys, wherein the one or more metals and/or one or more metal alloys are present in a high melting point phase and a low metal point phase, wherein the low melting point phase melts at a temperature of less than about 300° C.

2. The composition of matter of claim 1, wherein the low melting point phase when exposed to a temperature of greater than 50° C. but less than about 300° C. melts and forms intermetallic compounds with the high melting point phase.

3. The composition of matter of claim 1, wherein the intermetallic connections are formed in the composition at a level of less than 100%.

4. The composition of matter of claim 1, wherein the low melting point phase is present in an amount of at least 5% by weight of the composition of matter.

5. The composition of matter of claim 1, in the form of a sintering film.

6. A composition of matter comprising a metal or a metal alloy and a decomposable organic binder, which when exposed to a temperature of greater than 50° C., the metal or metal alloy sinters and is in the form of a film.

7. The composition of matter of claim 6, wherein the metal sinters in the composition at a level of less than 100%.

8. The composition of matter of claim 1 disposed between a semiconductor chip and a circuit board or a carrier substrate.

9. The composition of matter of claim 1 disposed on a surface of a silicon wafer, wherein the surface of the silicon wafer contains a metallization layer.

10. An article of commerce comprising the composition of matter of claim 5 in the form of a sintering film.

11. The article of commerce of claim 10, wherein the sintering film is disposed on a carrier.

12. The article of commerce of claim 11, wherein the carrier is a carrier film, a metal foil, or a ceramic support.

13. The composition of matter of claim 1, in which the one or more metals and/or one or more metal alloys contain vanadium, chromium, molybdenum, tungsten, manganese, iron, cobalt, nickel, palladium, platinum, copper, silver, gold, zinc, aluminum, indium, silicon, tin, antimony or bismuth.

14. The composition of matter of claim 1 in which the one or more metals and/or one or more metal alloys are coated onto a core.

15. The composition of matter of claim 1 further comprising graphene, carbon nanotubes, or conductive organic polymers.

16. The composition of matter of claim 1 further comprising a solid or semisolid organic binder.

17. The composition of matter of claim 16 in which the solid or semisolid organic binder has fluxing functionality.

18. The composition of matter of claim 17 in which the fluxing functionality is from groups selected from the group consisting of hydroxyl, carboxyl, anhydride, ester, amine, amide, thiol, thioester, and phosphate ester groups.

19. The composition of matter of claim 16 in which the binder is a compound with a softening point less than 50° C.

20. The composition of matter of claim 19 in which the binder is an acrylic resin or an alkylated polyvinylpyrrolidone.

21. The composition of matter of claim 19 in which the binder has fluxing functionality.

22. The composition of matter of claim 21 in which the binder is an acrylic resin functionalized with carboxylic acid or maleic anhydride, a copolymer of isobutylene and maleic anhydride, or a poly-alkylene carbonate copolymer with epoxide.

23. The composition of matter of claim 16 in which the binder is a compound that thermally decomposes at temperatures ≦350° C.

24. The composition of matter of claim 21 in which the binder is an acrylic resin or a copolymer of isobutylene-maleic anhydride.

25. The composition of matter of claim 1 further comprising a sintering aid selected from the group consisting of an alkali metal, an alkali metal salt, a transition metal, and a transition metal salt, in which the salts are alkali or transition metals coordinated with an organic acid.

26. The composition of matter of claim 25 in which the sintering aid is a metal salt, in which the metal is selected from the group consisting of Li, Na, K, Rb, Be, Mg, Ca, Sr, Ba, Ti, Zr, V, Nb, Ta, Cr, Mo, W, Mn, Fe, Ru, Os, Co, Rh, Ir, Ni, Pd, Pt, Cu, Ag, Au, Zn, Cd, B, Al, Ga, In, Si, Ge, Sn, Pb, N, P, As, Sb, and Bi; and in which the organic acid to coordinate with the metal salt is selected from the group consisting of formic, acetic, acrylic, methacrylic, propionic, butyric, valeric, caproic, caprylic, carpric, lauric, myristic, palmitic, stearic, oleic, linoleic, linolenic, cyclohexanecarboxylic, phenylacetic, benzoic, o-toluic, m-toluic, p-toluic, o-chlorobenzoic, m-chlorobenzoic, p-chlorobenzoic, o-bromobenzoic, m-bromobenzoic, p-bromobenzoic, o-nitrobenzoic, m-nitrobenzoic, p-nitrobenzoic, phthalic, isophthalic, terephthalic, salicylic, p-hydroxybenzoic, anthranilic, m-aminobenzoic, p-aminobenzoic, o-methoxybenzoic, m-methoxybenzoic, p-methoxybenzoic, oxalic, malonic, succinic, glutaric, adipic, pimelic, suberic, azelaic, sebacic, maleic, fumaric, hemimellitic, trimellitic, trimesic, malic, and citric acids, the branched chain isomers of these acids, and halogen-substituted derivatives if these acids.

27. The composition of matter of claim 25 in which the sintering aid is selected from the group consisting of lithium acetate, lithium acetylacetonate, lithium benzoate, lithium phosphate, palladium, palladium methacrylate, palladium (II) acetylacetonate, and tin(II) 2-ethyl hexanoate.

28. A process for preparing a sintering film comprising
(a) dispersing one or more metals and/or one or more metal alloys in a solvent, with or without a binder, to form a sintering paste;
(b) applying the sintering paste to a substrate, or
(c) infusing the sintering paste into a foam or mesh, and
(d) heating the sintering paste to dry it into the sintering film.

29. The process of claim 28 further comprising
(e) compressing the film at a temperature 300° C. and a pressure 15 Mpa, and/or
(f) laminating the film to a substrate.

30. The sintering film of claim 10 applied to a substrate in which the substrate is a carrier film, metal foil, silicon die, silicon wafer, metal circuit board, or ceramic support
